(19) United States
(12) Patent Application Publication
(10) Pub. No.: US 2024/0137473 A1
(43) Pub. Date: Apr. 25, 2024

(54) SYSTEM AND METHOD TO EFFICIENTLY PERFORM DATA ANALYTICS ON VEHICLE SENSOR DATA

(71) Applicant: Magna Electronics Inc., Auburn Hills, MI (US)

(72) Inventors: Anuj S. Potnis, Hösbach (DE); Sagar Sheth, Hösbach (DE); Manel Edo-Ros, Kleinostheim (DE)

(21) Appl. No.: 18/489,152

(22) Filed: Oct. 17, 2023

Related U.S. Application Data
(60) Provisional application No. 63/380,118, filed on Oct. 19, 2022.

(51) Int. Cl. H04N 7/18; B60W 50/14; G06V 10/764; G06V 10/80; G06V 20/56

(52) U.S. Cl. CPC H04N 7/188; B60W 50/14; G06V 10/764; G06V 10/809; G06V 20/56; B60W 2420/42; B60W 2420/52; B60W 2510/18; B60W 2554/4029

(57) ABSTRACT

A method for labeling events of interest in vehicular sensor data includes accessing sensor data captured by a plurality of sensors disposed at a vehicle, and providing a trigger condition including a plurality of threshold values. The trigger condition is satisfied when values representative of the sensor data satisfy each threshold value. An event of interest is identified when the trigger condition is satisfied at a point in time of the recording of sensor data. A visual indication of the event of interest is displayed on a graphical user interface. Visual elements derived from a portion of the sensor data representative of the event of interest are displayed on the graphical user interface. A label for the event of interest is received from a user. The label and the sensor data representative of the point in time are stored at a database time.

### CROSS REFERENCE TO RELATED APPLICATION

The present application claims the filing benefits of U.S. provisional application Ser. No. 63/380,118, filed Oct. 19, 2022, which is hereby incorporated herein by reference in its entirety.

### FIELD OF THE INVENTION

The present invention relates generally to a data processing system, and, more particularly, to a data processing system that analyzes data captured by one or more sensors at a vehicle.

### BACKGROUND OF THE INVENTION

Modern vehicles are equipped with many sensors that generate a vast quantity of data. Conventionally the captured sensor data is analyzed for events of interest manually, which is an expensive and time consuming process.

### SUMMARY OF THE INVENTION

A method for labeling events of interest in vehicular sensor data includes accessing sensor data captured by a plurality of sensors disposed at a vehicle. The method includes providing a trigger condition that includes a plurality of threshold values. The trigger condition is satisfied when values derived from the sensor data satisfy each of the plurality of threshold values. The method includes identifying, via processing the sensor data, an event of interest when the trigger condition is satisfied. The method also includes displaying, on a graphical user interface, a visual indication of the event of interest and displaying, on the graphical user interface, visual elements derived from a portion of the sensor data representative of the event of interest. The method includes receiving, from a user of the graphical user interface, a label for the event of interest. The method includes storing, at a database, the label and the portion of the sensor data representative of the event of interest.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensor system that incorporates cameras and radar sensors;

FIG. 2 is a view of a graphical user interface (GUI) of a data analysis system displaying sensor data captured by the sensor system of FIG. 1;

FIG. 3 is a view of exemplary graphical elements of the GUI of FIG. 2; and

FIGS. 4A-4C are timing diagrams of the data analysis system of FIG. 2.

### DESCRIPTION OF THE PREFERRED EMBODIMENTS

A vehicle sensor system and/or driver or driving assist system and/or object detection system and/or alert system operates to capture sensor data such as images exterior of the vehicle and may process the captured sensor data to display images and to detect objects at or near the vehicle and in the predicted path of the vehicle, such as to assist a driver of the vehicle in maneuvering the vehicle in a rearward direction. The sensor system includes a data processor or data processing system that is operable to receive image data from one or more cameras and provide an output to a display device for displaying images representative of the captured image data. The data processor is also operable to receive radar data from one or more radar sensors to detect objects at or around the vehicle. Optionally, the sensor system may provide a display, such as a rearview display or a top down or bird's eye or surround view display or the like.

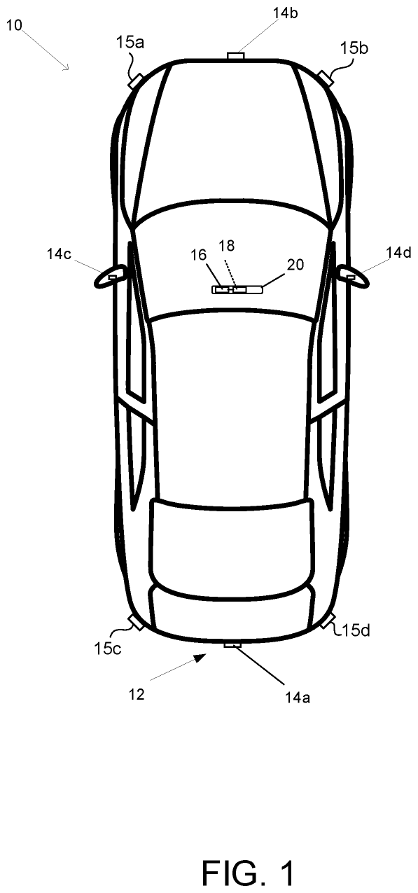

Referring now to the drawings and the illustrative embodiments depicted therein, a vehicle 10 includes an imaging system or sensor system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). The sensor system may additionally or alternatively include one or more other imaging sensors, such as lidar, radar sensors (e.g., corner radar sensors 15a-d), etc. Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Modern vehicles often come equipped with a large number of automatic sensors. Automatic sensors collect extremely large amounts of data. Functional performance testing for advanced driver assistance systems requires the features of the systems to be tested on large amounts of data collected by these sensors from vehicles worldwide. However, it is expensive to manually parse the data to find events of interest. For example, functional performance testing and product validation may include state-of-the-art data mining activity to capture and analyze interesting scenarios, maintaining databases, and performing the comparison over the different software and product versions.

Events of interest include special scenarios that the vehicle encounters while driving (e.g., while being driven by a driver or while being autonomously driven or controlled or maneuvered) that are useful for the development and/or validation of vehicle functions (e.g., lane keeping functions, adaptive cruise control, automatic emergency braking, and/or any other autonomous or semi-autonomous functions). Moreover, these events of interest, once found, generally must be analyzed to obtain ground truth (e.g., by a human annotator) before the event of interest can be used (e.g., for training).

Implementations herein include systems (i.e., a data analysis system) and methods that perform data analytics and extract relevant information from “big data” captured by vehicle sensors for further analysis for the development and validation of advanced driver assistance functions for vehicles. The analyzed data may be stored in databases and made available for future iterations of reprocessed data. Thus, these implementations facilitate quick and user-focused captured scenario analysis which conventionally (i.e., using a manual analysis approach) requires significantly more time and resources.

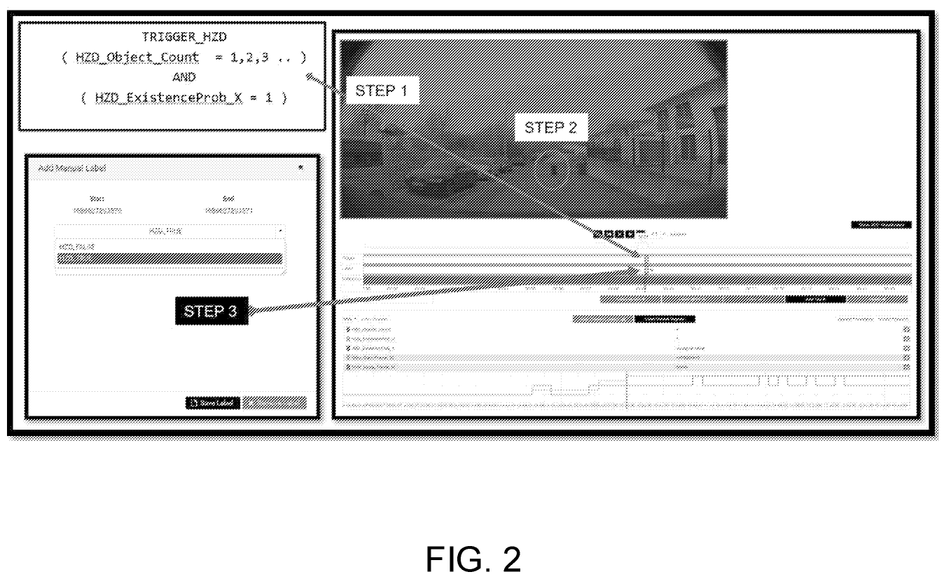

Referring now to FIG. 2, the data analysis system obtains or accesses previously captured sensor data from any number of sensors (i.e., a sensor data recording) of a vehicle. For example, the system obtains sensor data from one or more cameras, lidar, radar sensors, GPS sensors, accelerometers, ultrasonic sensors, vehicle status sensors (e.g., steering wheel angle, tire speed, acceleration pedal status, brake pedal status, etc.), and the like. The data may be retrieved via storage disposed at the vehicle (e.g., at the individual sensors or at a central data repository within the vehicle) or via wireless communications with the vehicle. Other data optionally is available to the system, such as signal bus data, debug data, prelabels, etc. The system applies or provides one or more rules to the values of the sensor data to identify predefined events of interest (i.e., step 1 of FIG. 2). For example, the rules establish or provide one or more triggers that are triggered when various combinations of the sensor data satisfy the trigger. In this example, a trigger or rule (i.e., “TRIGGER_HZD”) is triggered when an object count (i.e., “HZD_Object_Count”) found or derived from the sensor data is greater than zero and an existence probability (i.e., “HZD_ExistenceProb_X”) is above a threshold. In this example, the trigger conditions are based on image processing of image data captured by a camera (i.e., when processing image data detects one or more hazardous objects with a threshold probability). The triggers or rules define events of interest that may be useful in training one or more functions of the vehicle (e.g., via machine learning). The triggers may combine any number of rules based on any amount of data (i.e., sensor data and/or data resulting from processing sensor data, such as detected objects, classification of objects, environmental states, etc.).

The system provides the data to a user in a synchronized manner. For example, as shown in step 2 of FIG. 2, when the conditions of a trigger are satisfied, the system may automatically navigate to the appropriate point in the synchronized data so that the user may view and/or analyze all of the data available at the point in time (and any amount of time before and after) the trigger condition was satisfied. The data may be synchronized together with respect to time, such that the user may view sensor data within a sensor data recording for other sensors (i.e., sensors not involved in satisfying the trigger condition) at the same time as the corresponding sensor data for the triggering sensors. Optionally, the sensor data includes timestamps or other indicators or keys consistent across the sensor data for different sensors, and the system synchronizes the sensor data using the timestamps/indicators. For example, the system may synchronize image data captured by a camera and radar data captured by a radar sensor such that image data and radar data (or values derived from the data) captured at or near the same time is visible simultaneously to the user. The data may be synchronized via other means, such as based on vehicle position (i.e., a location the vehicle is at when the data is captured).

As shown in FIG. 2, a trigger condition was satisfied when an object was detected in the path of the vehicle. The system, upon determining that the trigger conditions were satisfied, synchronously provides at least some of the sensor data to the user (e.g., the sensor data configured by the user to be displayed as a result from the trigger condition), such that the user can view the sensor data (or results or conditions resulting from processing sensor data) that caused the trigger and any other available sensor data. Here, the system provides image data that was captured at the same time the trigger condition was satisfied (which may have been satisfied based on analysis of the captured image data and/or data from another sensor, such as a radar sensor), which allows the user to view the detected object. The data may take the form of plots or graphs (i.e., of sensor values), images, numerical or textual values, vectors, tables, etc.

The system may allow the user to navigate to any point within the data recording (such as by specifying any timestamp, any vehicle position, any distance traveled, etc.) and view all of the sensor data from the various sensors (and any data resulting from processing the sensor data) available at the particular point. For example, the system provides a menu or other visual tool that lists all available sensors and the user selects which sensor data is visible. The system may provide a timeline or other visual indicator of points in time along the data recording and any detected or identified events of interest (i.e., points in time when one or more trigger conditions are satisfied). For example, each event of interest is visually indicated on a timeline of the recording. A user or operator may navigate from an event of interest to any other event of interest immediately via one or more user inputs (e.g., via an interaction indication such as by selecting a “next event” button). The system may display the rationale for classifying the point in time as an event of interest (e.g., the data that resulted in the trigger condition being satisfied) along with any other ancillary data available.

The system optionally includes a labeling module that allows the user to label or otherwise annotate the event of interest. For example, as shown in step 3 of FIG. 2, the label module provides user input for the user to add a label to the event of interest. The label may include a selection from a drop down list (as shown here) or any other type of user input, such as a text field, radio buttons, voice input, etc. The label may be a comment, tag, classification, or any other input capable of being provided by the user. The tool may automatically process and/or store the labeled sample (i.e., the user label/annotation and associated sensor data) for future use in training or testing vehicular functions (i.e., as ground truth for the training sample). For example, a trigger condition may be satisfied when an object is detected in the path of the vehicle, when a pedestrian is detected, when the vehicle begins to skid, when an automatic emergency braking event occurs, etc. When the trigger condition is satisfied, visual elements derived from a portion of the sensor data may be displayed for the user. For example, image data associated with the same point in time when the trigger condition is satisfied is presented to the user (e.g., one or more frames of image data representative of the event of interest). The user may apply a label classifying the detected object (e.g., a vehicle, a pedestrian, etc.). The system may store (e.g., in a database) the label and/or image data (and any other associated sensor data or other data) for training a model (e.g., a machine learning model configured to classify detected objects. For example, a training sample that includes the sensor data may be provided to a machine learning model for training. The prediction generated by the machine learning model may be compared to the label provided by the user to train the model.

Optionally, the database storing the labeled data is available for report generation and/or any other tools such as statistical data analytics tools. The system allows multiple users simultaneously to access and review the data. The system and data may be stored on a distributed computing system (e.g., the “cloud”) to allow users access anywhere globally and allow for easy scaling with cloud and web applications. The results of the manually analyzed events may be automatically matched to system data generated by a newer software release and may be made available to compare across multiple system software releases.

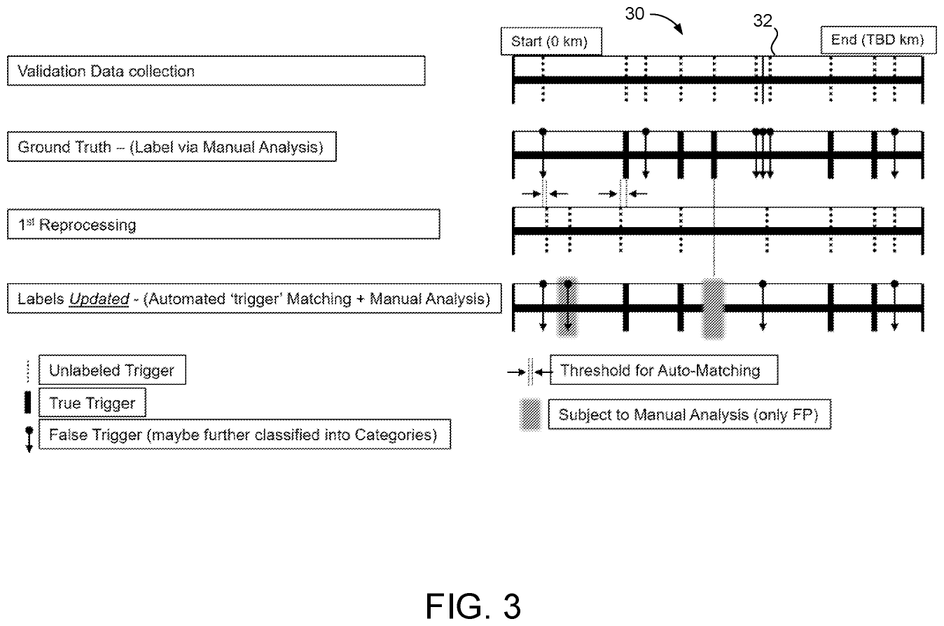

FIG. 3 illustrates exemplary graphical user interface (GUI) elements of the system that allow the user to find, evaluate, and label events of interest among big data acquired by multiple vehicle sensors from one or more vehicles. For example, the GUI elements include a timeline 30 with various trigger indications 32 indicating events of interest (e.g., triggering events) enabling the user to quickly determine optimal periods of time to evaluate. The GUI elements may include multiple different types of trigger indications, such as unlabeled trigger indications (i.e., trigger events not yet labeled by the user), true trigger indications (i.e., trigger events labeled and confirmed to be actual trigger events), and false trigger indications (i.e., events determined to not be actual trigger events, such as an object being mistakenly detected in the path of the vehicle when no such object existed). The trigger indications may be sorted into categories based on different types of events, such as a vehicle detected, lane markers lost, an emergency braking event, etc. The trigger indications may be displayed on the timeline, giving the user immediate feedback upon the approximate location and quantity of events of interest within the recording. The GUI elements may include indications of areas that are subject to manual analysis (e.g., require annotation or labeling from the user).

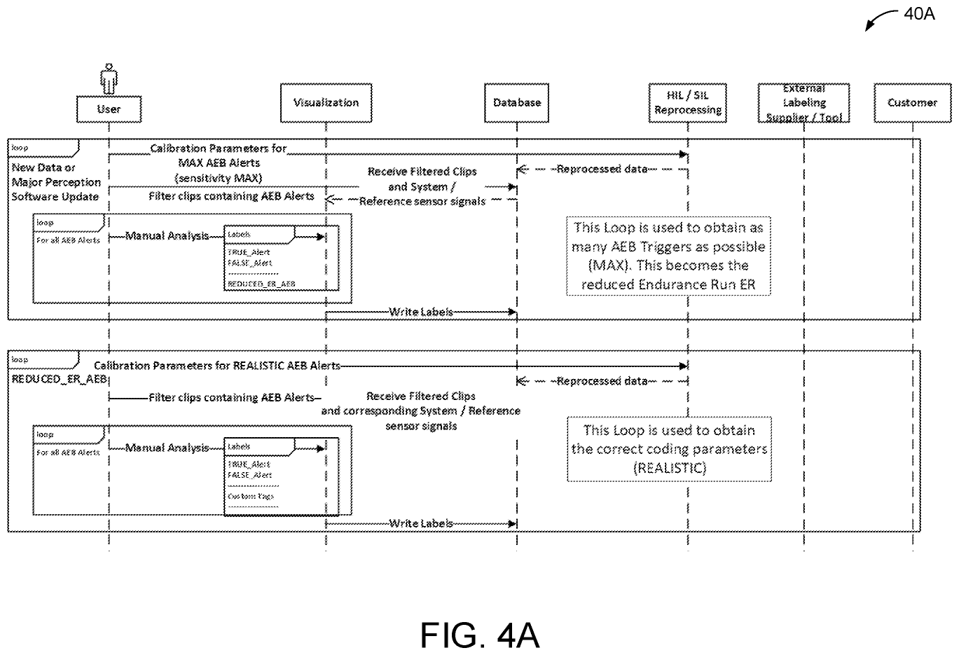

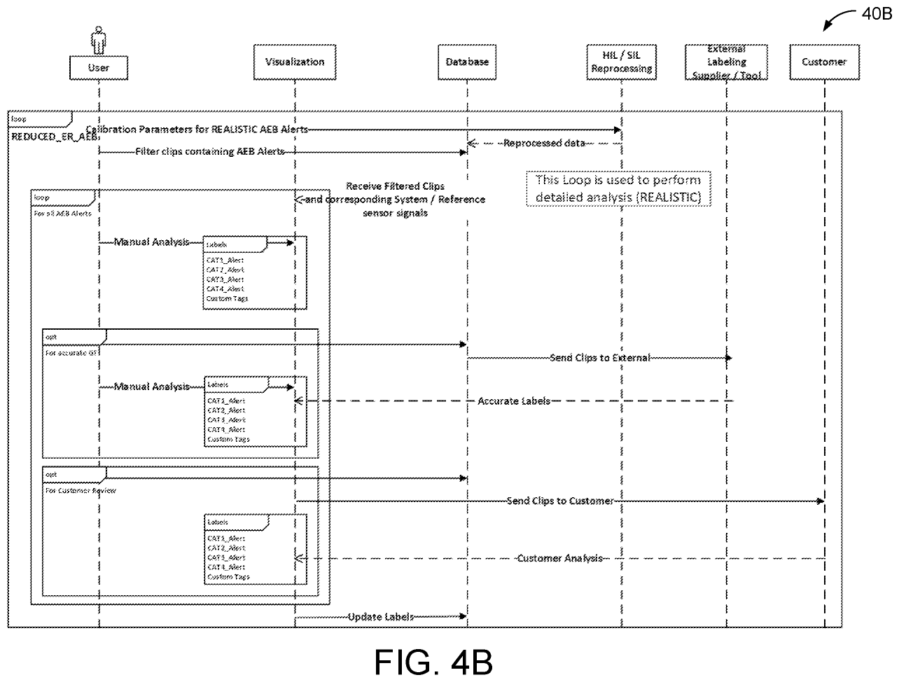

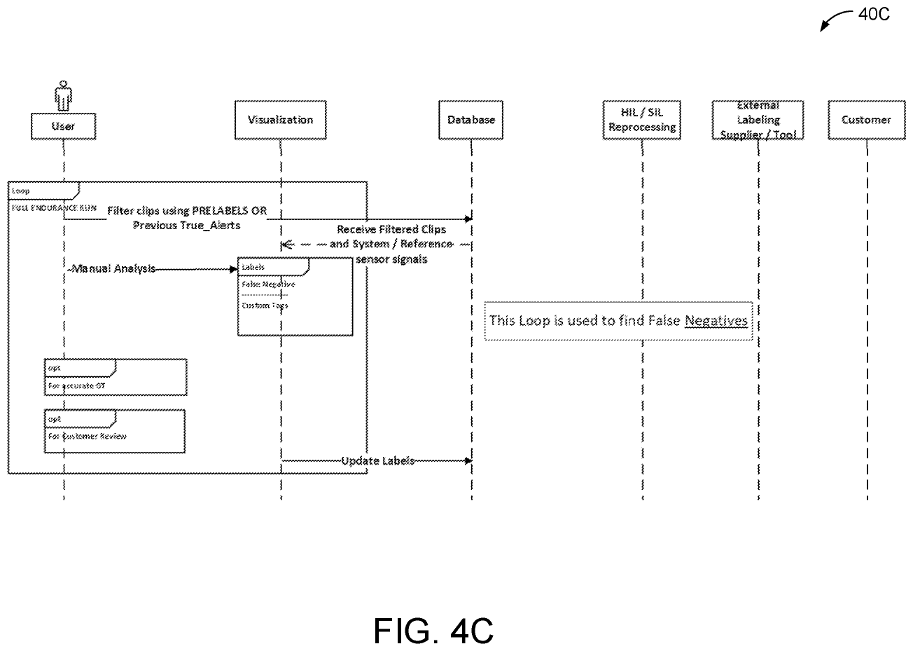

FIGS. 4A-4C includes exemplary timing diagrams 40A-C that includes interactions between a user of the system, a visualization module of the system (e.g., a GUI that the user interacts with, such as a GUI executing on a user device (e.g., mobile phone) or personal computing device (e.g., laptop, desktop, etc.), a database, hardware-in-the-loop (HIL) and software-in-the-loop (SIL) simulation programs or execution environments, an external labeling supplier/tool, and a customer.

The timing diagram 40A includes loops for obtaining maximum automatic emergency braking (AEB) triggers and obtaining correct coding parameters (FIG. 4A). Here, the user provides the HIL/SIL calibration parameters for AEB triggers/alerts. The HIL/SIL provides the database with reprocessed data (i.e., processed with the calibration parameters). The user filters the data/clips for data containing AEB alerts (e.g., via one or more trigger conditions). The database provides the filtered clips and any associated data (such as system/reference sensor signals) to a visualization tool (e.g., the GUI the user interacts with). The user performs analysis of the filtered clips by providing labels and/or categorization of the filtered clips. The labels/categories are then provided to the database to update the stored data accordingly. The timing diagram 40A continues with a loop for obtaining realistic AEB triggers.

The timing diagram 40B includes a loop for performing detailed analysis (FIG. 4B). Like in FIG. 4A, the user provides calibration parameters to the HIL/SIL, which provides preprocessed data to the database based on the calibration parameters. The user provides the appropriate filters to the database, which provides the filtered clips to the visualization tool. Here, the user categorizes and labels the clips, and based on the categorization/label, the filtered clips are provided to an external labeling supplier/tool or a customer. The timing diagram 40C includes a loop for determining false negatives (FIG. 4C). Here, the user filters clips using prelabels or previous filters and analyzes/labels false negatives.

Thus, the systems and methods described herein include a tool (e.g., an application with a GUI executing on processing hardware, such as a user device) that performs big data analytics on sensor data captured by a vehicle. Optionally, the GUI is executed on a user device associated with a user while the rest of the tool is executed on computing hardware (e.g., a server) remote from the user that communicates with the user device via a network (e.g., over the Internet). The system may process data captured by cameras, lidar, radar sensors, accelerometers, GPS sensors, etc. The system uses triggers to determine and locate events of interest and allows automatic or manual processing of the events of interest to provide a ground truth for testing vehicular functionality.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A method for labeling events of interest in vehicular sensor data, the method comprising:
accessing sensor data captured by a plurality of sensors disposed at a vehicle;
providing a trigger condition comprising a plurality of threshold values, wherein the trigger condition is satisfied when values derived from the sensor data satisfy each of the plurality of threshold values;
identifying, via processing the sensor data, an event of interest when the trigger condition is satisfied;
displaying, on a graphical user interface, a visual indication of the event of interest;
displaying, on the graphical user interface, visual elements derived from a portion of the sensor data representative of the event of interest;
receiving, from a user of the graphical user interface, a label for the event of interest; and
storing, at a database, the label and the portion of the sensor data representative of the event of interest.

2. The method of claim 1, wherein the plurality of sensors comprises at least one selected from the group consisting of (i) a camera, (ii) a radar sensor, (iii) a lidar sensor, and (iv) a GPS sensor.

3. The method of claim 1, wherein the plurality of sensors comprises a plurality of cameras.

4. The method of claim 1, wherein accessing sensor data captured by the plurality of sensors disposed at the vehicle comprises recording the sensor data using the plurality of sensors while the plurality of sensors are disposed at the vehicle.

5. The method of claim 1, wherein the visual indication of the event of interest comprises a visual indication of a particular point in time captured by the sensor data.

6. The method of claim 5, wherein the visual indication of the particular point in time comprises a marker on a timeline, and wherein the timeline represents a length of a recording of sensor data.

7. The method of claim 5, further comprising training a model using the label and the portion of the sensor data representative of the particular point in time.

8. The method of claim 7, wherein the model comprises a machine learning model.

9. The method of claim 1, wherein the label comprises a ground truth associated with the portion of the sensor data representative of a particular point in time captured by the sensor data.

10. The method of claim 1, wherein one of the plurality of threshold values represents a number of objects detected based on the sensor data.

11. The method of claim 1, wherein the event of interest comprises a hazardous object in a path of the vehicle.

12. The method of claim 1, wherein displaying the visual elements derived from the portion of the sensor data representative of the event of interest comprises displaying a frame of image data captured by a camera.

13. The method of claim 1, wherein displaying the visual elements derived from the portion of the sensor data representative of the event of interest comprises displaying a waveform representative of the values derived from the sensor data.

14. The method of claim 1, wherein the method further comprises:
receiving, from the user of the graphical user interface, an interaction indication indicating a user interaction with the graphical user interface;
responsive to receiving the interaction indication, displaying, on the graphical user interface, a second visual indication of a second point in time of a second event of interest relative to a length of a recording of sensor data; and
displaying, on the graphical user interface, second visual elements derived from a second portion of the sensor data representative of the second point in time.

15. The method of claim 1, wherein the event of interest represents an automatic emergency braking event by the vehicle.

16. A method for labeling events of interest in vehicular sensor data, the method comprising:
accessing sensor data captured by a plurality of sensors disposed at a vehicle;
providing a trigger condition comprising a plurality of threshold values, wherein the trigger condition is satisfied when values derived from the sensor data satisfy each of the plurality of threshold values;
identifying, via processing the sensor data, an event of interest when the trigger condition is satisfied;
displaying, on a graphical user interface, a visual indication of the event of interest;
displaying, on the graphical user interface, visual elements derived from a portion of the sensor data representative of the event of interest;
receiving, from a user of the graphical user interface, a label for the event of interest, wherein the label comprises a ground truth associated with the portion of the sensor data representative of the event of interest;
storing, at a database, the label and the portion of the sensor data representative of the event of interest; and
training a model using the label and the portion of the sensor data representative of the event of interest.

17. The method of claim 16, wherein the model comprises a machine learning model.

18. The method of claim 16, wherein the plurality of sensors comprises at least one selected from the group consisting of (i) a camera, (ii) a radar sensor, (iii) a lidar sensor, and (iv) a GPS sensor.

19. The method of claim 16, wherein the plurality of sensors comprises a plurality of cameras.

20. The method of claim 16, wherein accessing sensor data captured by the plurality of sensors disposed at the vehicle comprises recording, using the plurality of sensors while the plurality of sensors are disposed at the vehicle, the sensor data.

21. A method for labeling events of interest in vehicular sensor data, the method comprising:
recording sensor data using a plurality of sensors disposed at a vehicle;
providing a trigger condition comprising a plurality of threshold values, wherein the trigger condition is satisfied when values derived from the recorded sensor data satisfy each of the plurality of threshold values;
identifying, via processing the recorded sensor data, an event of interest when the trigger condition is satisfied, wherein the event of interest comprises a hazardous object in a path of the vehicle;
displaying, on a graphical user interface, a visual indication of the event of interest, wherein the visual indication of the event of interest comprises a visual indication of a particular point in time along the recorded sensor data;
displaying, on the graphical user interface, visual elements derived from a portion of the recorded sensor data representative of the event of interest;
receiving, from a user of the graphical user interface, a label for the event of interest; and
storing, at a database, the label and the portion of the recorded sensor data representative of the event of interest.

22. The method of claim 21, wherein the visual indication of the particular point in time comprises a marker on a timeline, and wherein the timeline represents a length of the recording of sensor data.

23. The method of claim 21, wherein displaying the visual elements derived from the portion of the recorded sensor data representative of the event of interest comprises displaying a frame of image data captured by a camera.

24. The method of claim 21, wherein displaying the visual elements derived from the portion of the recorded sensor data representative of the event of interest comprises displaying a waveform representative of the values derived from the recorded sensor data.
